(19) United States
(12) Patent Application Publication
(10) Pub. No.: US 2019/0007485 A1
(43) Pub. Date: Jan. 3, 2019

(54) METHOD AND APPARATUS FOR EXCHANGING DATA IN WIRELESS COMMUNICATION SYSTEM

(71) Applicant: LG ELECTRONICS INC., Seoul (KR)

(72) Inventors: Dongcheol KIM, Seoul (KR); Byungjoo LEE, Seoul (KR); Giwon PARK, Seoul (KR); Youngjun JO, Seoul (KR); Hyunhee PARK, Seoul (KR); Taesung LIM, Seoul (KR)

(73) Assignee: LG ELECTRONICS INC., Seoul (KR)

(21) Appl. No.: 15/745,422

(22) PCT Filed: Jul. 15, 2016
(86) PCT No.: PCT/KR2016/007730

§ 371 Date: May 17, 2018

Related U.S. Application Data
(60) Provisional application No. 62/193,591, filed on Jul. 17, 2015.
(60) Provisional application No. 62/208,797, filed on Aug. 23, 2015.

(51) Int. Cl. H04L 29/08; H04W 8/00; H04W 48/16

(52) U.S. Cl. CPC H04L 67/1046; H04W 84/18; H04W 48/16; H04W 8/005

(57) ABSTRACT

The present specification relates to a method for performing, by a NAN terminal, a data exchange in a wireless communication system.

### CROSS-REFERENCE TO RELATED APPLICATIONS

This application is the National Stage filing under 35 U.S.C. 371 of International Application No. PCT/KR2016/007730, filed on Jul. 15, 2016, which claims the benefit of U.S. Provisional Application Nos. 62/193,591, filed on Jul. 17, 2015 and 62/208,797, filed on Aug. 23, 2015, the contents of which are all hereby incorporated by reference herein in their entirety.

### TECHNICAL FIELD

The present specification relates to a wireless communication system, and more particularly, to a method for a NAN (neighbor awareness networking) terminal to exchange a data in a wireless communication system and an apparatus therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

### DISCLOSURE OF THE INVENTION

### Technical Tasks

An object of the present specification is to provide a method for a NAN terminal to exchange a data in a wireless communication system and an apparatus therefor.

Another object of the present specification is to provide a method for a NAN terminal to exchange a data by forming or joining a NAN data group in a wireless communication system.

Another object of the present specification is to provide a method of exchanging a data using internal information of a NAN terminal.

The other object of the present specification is to provide information indicating a function supported by a NAN terminal.

### Technical Solution

According to one embodiment of the present specification, it is able to provide a method for a NAN terminal to perform data exchange. A method of performing data exchange, which is performed by a NAN (neighbor awareness networking) terminal in a wireless communication system, includes the steps of transmitting, by a first NAN terminal, a first frame including NAN capability attribute information to a second NAN terminal, receiving a second frame from the second NAN terminal in response to the first frame, and performing data exchange for a first service with the second NAN terminal in a NAN data path based on a NAN data group. In this case, if a NAN persistent data group capability field among the NAN capability attribute information indicates that the first NAN terminal supports a NAN persistent data group function, the first frame including NAN persistent data group information is transmitted to the second NAN terminal and the NAN data path can be formed based on the NAN persistent data group information.

According to one embodiment of the present specification, a first NAN terminal performing data exchange in a wireless communication system includes a reception module configured to receive information from an external device, a transmission module configured to transmit information to an external device, and a processor configured to control the reception module and the transmission module, the processor configured to control the transmission module to transmit a first frame including NAN capability attribute information to a second NAN terminal, the processor configured to control the reception module to receive a second frame from the second NAN terminal in response to the first frame, the processor configured to perform data exchange for a first service with the second NAN terminal in a NAN data path based on a NAN data group. In this case, if a NAN persistent data group capability field among the NAN capability attribute information indicates that the first NAN terminal supports a NAN persistent data group function, the first frame including NAN persistent data group information is transmitted to the second NAN terminal and the NAN data path can be formed based on the NAN persistent data group information.

Following items can be commonly applied to a method of performing data exchange in a wireless communication system and a NAN terminal device.

According to one embodiment of the present specification, the first NAN terminal and the second NAN terminal may correspond to NAN terminals which have joined the NAN data group. In this case, the NAN data group may correspond to a group for the first service.

According to one embodiment of the present specification, if the first NAN terminal firstly joins the NAN data group for the first service, the first NAN terminal performs authentication and association procedures after receiving the second frame from the second NAN terminal and may be able to join the NAN data group based on the NAN persistent data group information.

According to one embodiment of the present specification, the data exchange for the first service can be performed in the NAN data path after the first NAN terminal joins the NAN data group.

According to one embodiment of the present specification, if the NAN data group is formed for the first time, the first NAN terminal and the second NAN terminal can store information on the NAN data group.

According to one embodiment of the present specification, when the first NAN terminal rejoins the NAN data group for the first service, if the first NAN terminal receives the second frame from the second NAN terminal, the first NAN terminal can join the NAN data group based on first information and the NAN persistent data group information without performing authentication and association procedures.

According to one embodiment of the present specification, the first information may correspond to information stored in the first NAN terminal when the first NAN terminal firstly joins the NAN data group for the first service.

According to one embodiment of the present specification, if the first NAN terminal joins the NAN data group, the second NAN terminal can provide information on the first NAN terminal to a different NAN terminal belonging to the NAN data group.

According to one embodiment of the present specification, if the second frame is received from the second NAN terminal, discovery for the first service can be completed.

And, the first frame and the second frame may correspond to frames which are exchanged in a step of forming the NAN data path for the first service after discovery for the first service is completed.

And, the NAN persistent data group information can include at least one selected from the group consisting of an address, a NAN data group ID, and scheduling information.

According to one embodiment of the present specification, the NAN capability attribute information can further include at least one field selected from the group consisting of a NAN extended service discovery field, a NAN ranging field, a NAN data link field, and a NAN discovery proxy field.

### Advantageous Effects

According to the present specification, it is able to provide a method for a NAN terminal to exchange a data in a wireless communication system and an apparatus therefor.

According to the present specification, it is able to provide a method for a NAN terminal to exchange a data by forming or joining a NAN data group in a wireless communication system.

According to the present specification, it is able to provide a method of exchanging a data using internal information of a NAN terminal.

According to the present specification, it is able to provide information indicating a function supported by a NAN terminal.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram illustrating an exemplary structure of IEEE 802.11 system;

FIGS. 2 and 3 are diagrams illustrating examples of a NAN cluster;

FIG. 4 illustrates an example of a structure of a NAN device;

FIGS. 5 and 6 illustrate relations between NAN components;

FIG. 7 is a diagram illustrating a state transition of a NAN device;

FIG. 8 is a diagram illustrating a discovery window and the like;

FIG. 9 is a diagram illustrating a discovery window;

FIG. 10 is a diagram illustrating a method of configuring a data link;

FIG. 11 is a diagram illustrating a method for a NAN terminal to form a data path based on a NAN persistent data group;

FIG. 12 is a flowchart for a method of configuring a NAN persistent data group;

FIG. 13 is a block diagram for a terminal device.

### BEST MODE

### Mode for Invention

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “ . . . unit”, “ . . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

Structure of WLAN System

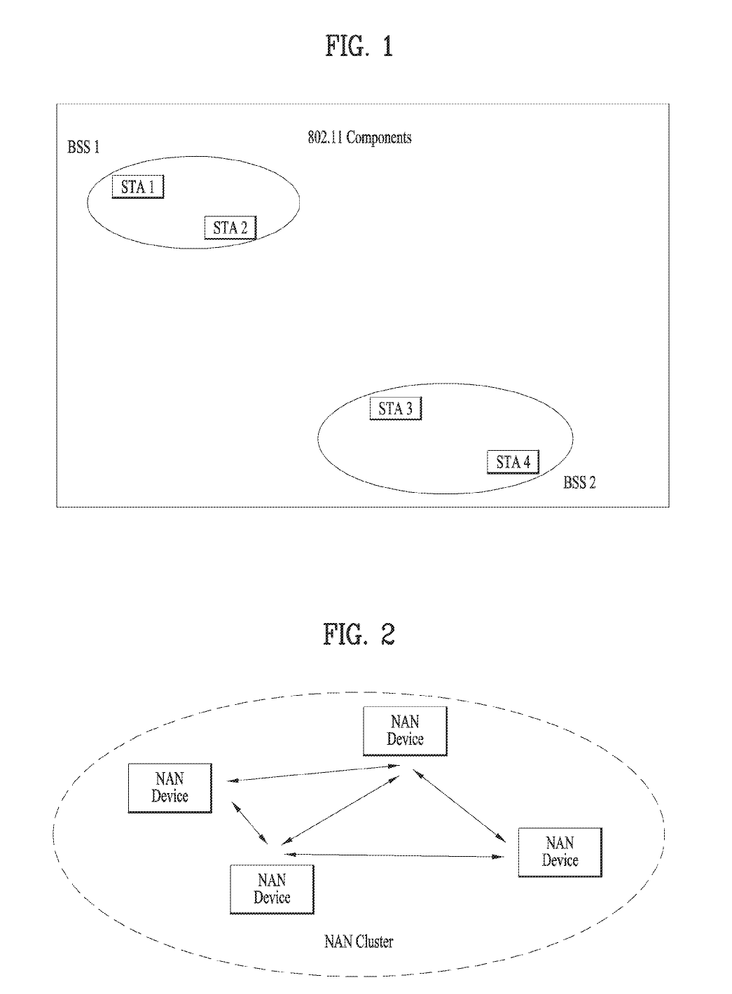

FIG. 1 is a diagram illustrating an exemplary structure of IEEE 802.11 system to which the present invention is applicable.

IEEE 802.11 structure may include a plurality of components and WLAN supportive of transparent STA mobility for an upper layer can be provided by interactions between the components. A basic service set (BSS) may correspond to a basic component block in IEEE 802.11 WLAN. FIG. 1 shows one example that two basic service sets BSS 1 and BSS 2 exist and that 2 STAs are included as members of each BSS. In particular, STA 1 and STA 2 are included in the BSS 1 and STA 3 and STA 4 are included in the BSS 2. In FIG. 1, an oval indicating the BSS can be understood as indicating a coverage area in which the STAs included in the corresponding BSS maintain communication. This area may be called a basic service area (BSA). Once the STA moves out of the BSA, it is unable to directly communicate with other STAs within the corresponding BSA.

A most basic type of BSS in IEEE 802.11 WLAN is an independent BSS (IBSS). For instance, IBSS can have a minimum configuration including 2 STAs only. Moreover, the BSS (e.g., BSS 1 or BSS 2) shown in FIG. 1, which has the simplest configuration and in which other components are omitted, may correspond to a representative example of the IBSS. Such a configuration is possible if STAs can directly communicate with each other. Moreover, the above-mentioned WLAN is not configured according to a devised plan but can be configured under the necessity of WLAN. And, this may be called an ad-hoc network.

If an STA is turned on/off or enters/escapes from a BSS area, membership of the STA in a BSS can be dynamically changed. In order to obtain the membership of the BSS, the STA can join the BSS using a synchronization procedure. In order to access all services of the BSS based structure, the STA should be associated with the BSS. This association may be dynamically configured or may include a use of a DSS (distribution system service).

Additionally, FIG. 1 shows components such as a DS (distribution system), a DSM (distribution system medium), an AP (access point) and the like.

In WLAN, a direct station-to-station distance can be restricted by PHY capability. In some cases, the restriction of the distance may be sufficient enough. However, in some cases, communication between stations located far away from each other may be necessary. In order to support extended coverage, the DS (distribution system) may be configured.

The DS means a structure in which BSSs are interconnected with each other. Specifically, the BSS may exist as an extended type of component of a network consisting of a plurality of BSSs instead of an independently existing entity as shown in FIG. 1.

The DS corresponds to a logical concept and can be specified by a characteristic of the DSM. Regarding this, IEEE 802.11 standard logically distinguishes a wireless medium (WM) from the DSM. Each of the logical media is used for a different purpose and is used as a different component. According to the definition of the IEEE 802.11 standard, the media are not limited to be identical to each other or to be different from each other. Since a plurality of the media are logically different from each other, flexibility of IEEE 802.11 WLAN structure (a DS structure or a different network structure) can be explained. In particular, the IEEE 802.11 WLAN structure can be implemented in various ways and the WLAN structure can be independently specified by a physical characteristic of each implementation case.

The DS can support a mobile device in a manner of providing seamless integration of a plurality of BSSs and logical services necessary for handling an address to a destination.

The AP enables associated STAs to access the DS through the WM and corresponds to an entity having STA functionality. Data can be transferred between the BSS and the DS through the AP. For instance, as shown in FIG. 1, while each of the STA 2 and STA 3 have STA functionality, the STA 2 and STA 3 provide functions of enabling associated STAs (STA 1 and STA 4) to access the DS. And, since all APs basically correspond to an STA, all APs correspond to an addressable entity. An address used by the AP for communication in the WM should not be identical to an address used by the AP for communication in the DSM.

Data transmitted from one of STAs associated with an AP to an STA address of the AP is always received in an uncontrolled port and the data can be processed by an IEEE 802.1X port access entity. Moreover, if a controlled port is authenticated, transmission data (or frame) can be delivered to a DS.

Layer Structure

Operations of the STA which operates in a wireless LAN system can be explained in terms of the layer structure. In terms of a device configuration, the layer structure can be implemented by a processor. The STA may have a structure of a plurality of layers. For example, a main layer structure handled in the 802.11 standard document includes a MAC sublayer and a physical (PHY) layer on a data link layer (DLL). The PHY layer may include a physical layer convergence procedure (PLCP) entity, a physical medium dependent (PMD) entity, etc. The MAC sublayer and the PHY layer conceptually include management entities called MAC sublayer management entity (MLME) and physical layer management entity (PLME), respectively. These entities provide a layer management service interface for performing a layer management function.

A station management entity (SME) is present within each STA in order to provide an accurate MAC operation. The SME is a layer-independent entity that may be considered as existing in a separate management plane or as being off to the side. Detailed functions of the SME are not specified in this document but it may be generally considered as being responsible for functions of gathering layer-dependent status from the various layer management entities (LMEs), setting values of layer-specific parameters similar to each other. The SME may perform such functions on behalf of general system management entities and may implement a standard management protocol.

The aforementioned entities interact with each other in various ways. For example, the entities may interact with each other by exchanging GET/SET primitives. The primitive means a set of elements or parameters related to a specific purpose. XX-GET.request primitive is used for requesting a value of a given MIB attribute (management information based attribute). XX-GET.confirm primitive is used for returning an appropriate MIB attribute value if a status is ‘success’, otherwise it is used for returning an error indication in a status field. XX-SET.request primitive is used to request that an indicated MIB attribute be set to a given value. If this MIB attribute implies a specific action, this requests that the action be performed. And, XX-SET.confirm primitive is used such that, if the status is ‘success’, this confirms that the indicated MIB attribute has been set to the requested value, otherwise it is used to return an error condition in the status field. If this MIB attribute implies a specific action, this confirms that the action has been performed.

Moreover, the MLME and the SME may exchange various MLME_GET/SET primitives through an MLME SAP (service access point). Furthermore, various PLME_GET/SET primitives may be exchanged between the PLME and the SME through PLME_SAP and may be exchanged between the MLME and the PLME through an MLME-PLME_SAP.

NAN (Neighbor Awareness Network) Topology

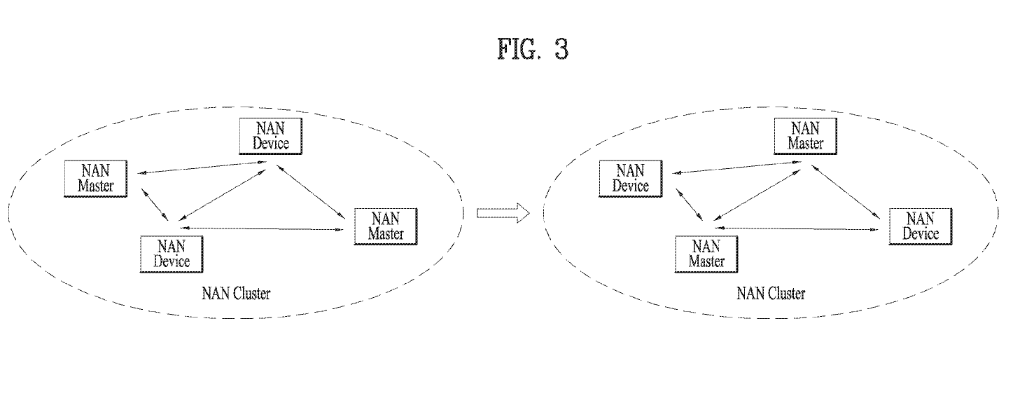

A NAN network can be constructed with NAN devices (terminals) that use a set of identical NAN parameters (e.g., a time interval between consecutive discovery windows, an interval of a discovery window, a beacon interval, a NAN channel, etc.). A NAN cluster can be formed by NAN devices and the NAN cluster means a set of NAN devices that are synchronized on the same discovery window schedule. And, a set of the same NAN parameters is used in the NAN cluster. FIG. 2 illustrates an example of the NAN cluster. A NAN device included in the NAN cluster may directly transmit a multicast/unicast service discovery frame to a different NAN device within a range of the discovery window. As shown in FIG. 3, at least one NAN master may exist in a NAN cluster and the NAN master may be changed. Moreover, the NAN master may transmit all of a synchronization beacon frame, discovery beacon frame and service discovery frame.

NAN Device Architecture

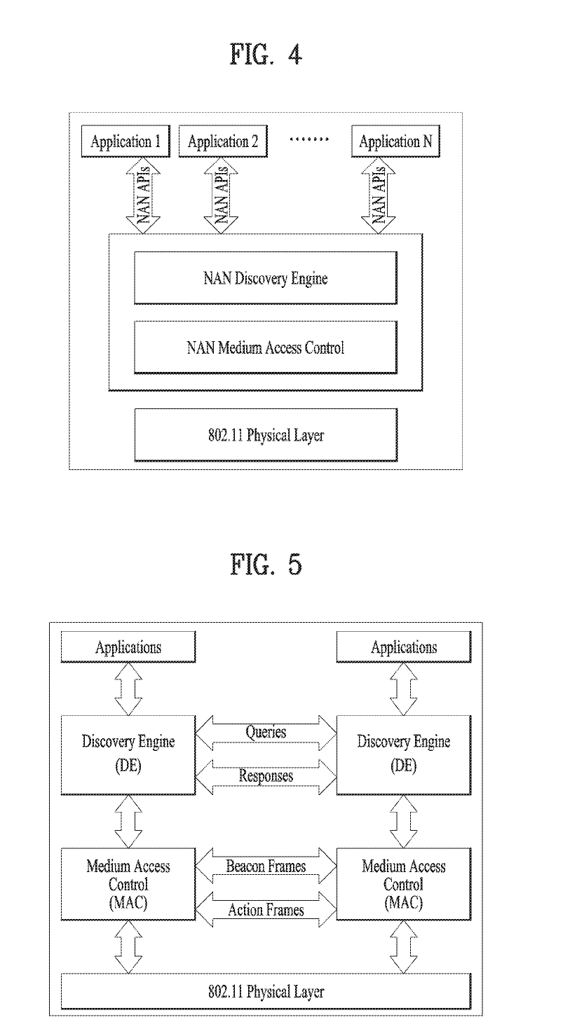

FIG. 4 illustrates an example of a structure of a NAN device (terminal). Referring to FIG. 4, the NAN device is based on a physical layer in 802.11 and its main components correspond to a NAN discovery engine, a NAN MAC (medium access control), and NAN APIs connected to respective applications (e.g., Application 1, Application 2, . . . , Application N).

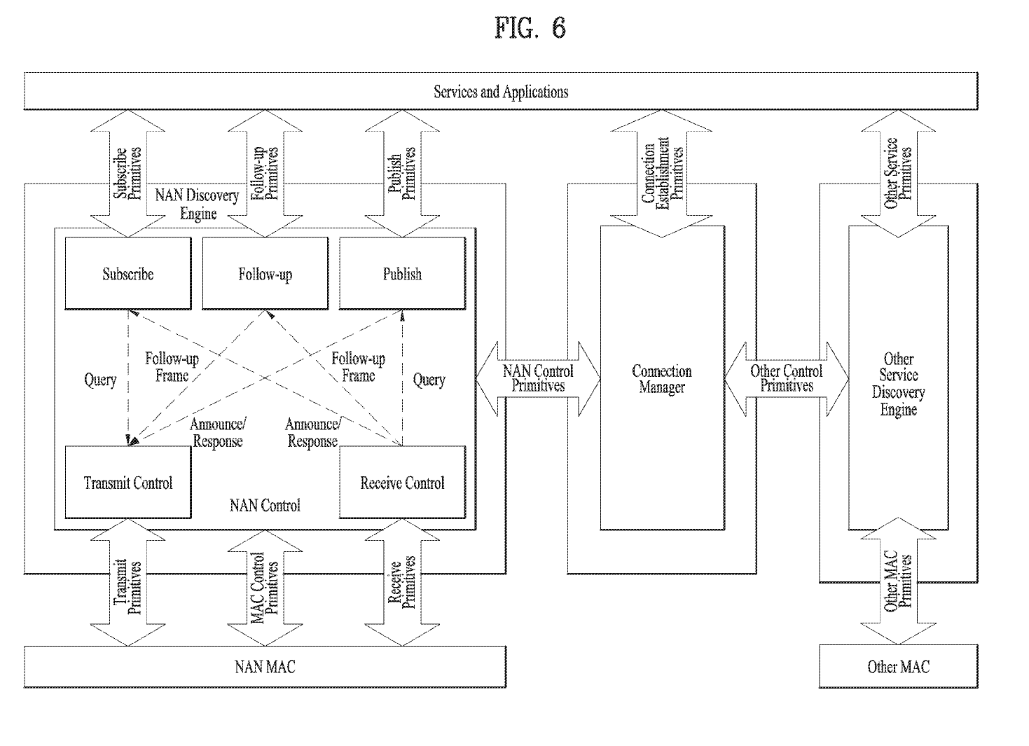

FIGS. 5 and 6 illustrate relations between NAN components. Service requests and responses are processed through the NAN discovery engine, and the NAN beacon frames and the service discovery frames are processed by the NAN MAC. The NAN discovery engine may provide functions of subscribing, publishing, and following-up. The publish/subscribe functions are operated by services/applications through a service interface. If the publish/subscribe commands are executed, instances for the publish/subscribe functions are generated. Each of the instances is driven independently and a plurality of instances can be driven simultaneously in accordance with the implementation. The follow-up function corresponds to means for the services/applications that transceive specific service information.

Role and State of NAN Device

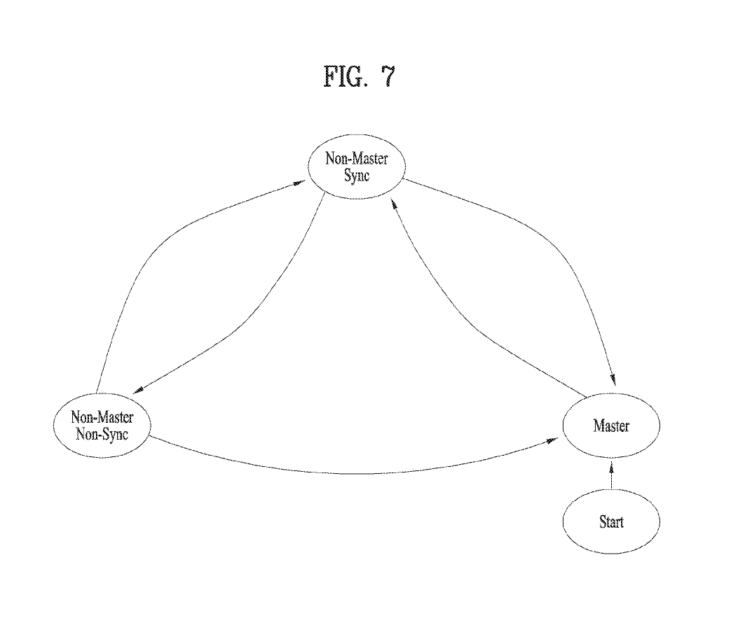

As mentioned in the foregoing description, a NAN device (terminal) can serve as a NAN master and the NAN master can be changed. In other words, roles and states of the NAN device can be shifted in various ways and related examples are illustrated in FIG. 7. The roles and states, which the NAN device can have, may include a master (hereinafter, the master means a state of master role and sync), a Non-master sync, and a Non-master Non-sync. Transmission availability of the discovery beacon frame and/or the synchronization beacon frame can be determined according to each of the roles and states and it may be set as illustrated in Table 1.

TABLE 1

| Role and State | Discovery Beacon | Synchronization Beacon |
|---|---|---|
| Master | Transmission Possible | Transmission Possible |
| Non-Master Sync | Transmission Impossible | Transmission Possible |
| Non-Master Non- | Transmission Impossible | Transmission Impossible |
| Sync | | |

The state of the NAN device can be determined according to a master rank (MR). The master rank indicates the preference of the NAN device to serve as the NAN master. In particular, a high master rank means strong preference for the NAN master. The NAN MR can be determined by Master Preference, Random Factor, Device MAC address, and the like according to Formula 1.

MasterRank=MasterPreference*2⁵⁶+RandomFactor*2⁴⁸+MAC[5]*2⁴⁰+ . . . +MAC[0] [Formula 1]

In Formula 1, the Master Preference, Random Factor, Device MAC address may be indicated through a master indication attribute. The master indication attributes may be set as illustrated in Table 2.

TABLE 2

| Field Name | Size (Octets) | Value | Description |
|---|---|---|---|
| Attribute ID | 1 | 0x00 | Identifies the type of |
| | | | NAN attribute. |
| Length | 2 | 2 | Length of the following |
| | | | field in the attribute |
| Master Preference | 1 | 0-255 | Information that is used |
| | | | to indicate a NAN |
| | | | Device's preference to |
| | | | serve as the role of |
| | | | Master, with a larger |
| | | | value indicating a higher |
| | | | preference. |
| Random Factor | 1 | 0-255 | A random number |
| | | | selected by the sending |
| | | | NAN Device. |

Regarding the above MR, in case of a NAN device that activates a NAN service and initiates a NAN cluster, each of the Master Preference and the Random Factor is set to 0 and NANWarmUp is reset. The NAN device should set a Master Preference field value in the master indication attribute to a value greater than 0 and a Random Factor value in the master indication attribute to a new value until when the NANWarmUp expires. When a NAN device joins a NAN cluster in which the Master Preference of an anchor master is set to a value greater than 0, the corresponding NAN device may set the Master Preference to a value greater than 0 and the Random Factor to a new value irrespective of expiration of the NANWarmUp.

Moreover, a NAN device can become an anchor master of a NAN cluster depending on an MR value. That is, all NAN devices have capabilities of operating as the anchor master. The anchor master means the device that has a highest MR and a smallest AMBTT (anchor master beacon transmit time) value and has a hop count (HC) (to the anchor master) set to 0 in the NAN cluster. In the NAN cluster, two anchor masters may exist temporarily but a single anchor master is a principle of the NAN cluster. If a NAN device becomes an anchor master of a currently existing NAN cluster, the NAN device adopts TSF used in the currently existing NAN cluster without any change.

The NAN device can become the anchor master in the following cases: if a new NAN cluster is initiated; if the master rank is changed (e.g., if an MR value of a different NAN device is changed or if an MR value of the anchor master is changed); or if a beacon frame of the current anchor master is not received any more. In addition, if the MR value of the different NAN device is changed or if the MR value of the anchor master is changed, the NAN device may lose the status of the anchor master. The anchor master can be determined according to an anchor master selection algorithm in the following description. In particular, the anchor master selection algorithm is the algorithm for determining which NAN device becomes the anchor master of the NAN cluster. And, when each NAN device joins the NAN cluster, the anchor master selection algorithm is driven.

If a NAN device initiates a new NAN cluster, the NAN device becomes the anchor master of the new NAN cluster. If a NAN synchronization beacon frame has a hop count in excess of a threshold, the NAN synchronization beacon frame is not used by NAN devices. And, other NAN synchronization beacon frames except the above-mentioned NAN synchronization beacon frame are used to determine the anchor master of the new NAN cluster.

If receiving the NAN synchronization beacon frame having the hop count equal to or less than the threshold, the NAN device compares an anchor master rank value in the beacon frame with a stored anchor master rank value. If the stored anchor master rank value is greater than the anchor master value in the beacon frame, the NAN device discards the anchor master value in the beacon frame. If the stored anchor master value is less than the anchor master value in the beacon frame, the NAN device newly stores values greater by 1 than the anchor master rank and the hop count included in the beacon frame and an AMBTT value in the beacon frame. If the stored anchor master rank value is equal to the anchor master value in the beacon frame, the NAN device compares hop counters. Then, if a hop count value in the beacon frame is greater than a stored value, the NAN device discards the received beacon frame. If the hop count value in the beacon frame is equal to (the stored value−1) and if an AMBTT value is greater than the stored value, the NAN device newly stores the AMBTT value in the beacon frame. If the hop count value in the beacon frame is less than (the stored value−1), the NAN device increases the hop count value in the beacon frame by 1. The stored AMBTT value is updated according to the following rules. If the received beacon frame is transmitted by the anchor master, the AMBTT value is set to the lowest four octets of time stamp included in the received beacon frame. If the received beacon frame is transmitted from a NAN master or non-master sync device, the AMBTT value is set to a value included in a NAN cluster attribute in the received beacon frame.

Meanwhile, a TSF timer of a NAN device exceeds the stored AMBTT value by more than 16*512 TUs (e.g., 16 DW periods), the NAN device may assume itself as an anchor master and then update an anchor master record. In addition, if any of MR related components (e.g., Master Preference, Random Factor, MAC Address, etc.) is changed, a NAN device not corresponding to the anchor master compares the changed MR with a stored value. If the changed MR of the NAN device is greater than the stored value, the corresponding NAN device may assume itself as the anchor master and then update the anchor master record.

Moreover, a NAN device may set anchor master fields of the cluster attributes in the NAN synchronization and discovery beacon frames to values in the anchor master record, except that the anchor master sets the AMBTT value to a TSF value of corresponding beacon transmission. The NAN device, which transmits the NAN synchronization beacon frame or the discovery beacon frame, may be confirmed that the TSF in the beacon frame is derived from the same anchor master included in the cluster attribute.

Moreover, a NAN device may adopt a TSF timer value in a NAN beacon received with the same cluster ID in the following case: i) if the NAN beacon indicates an anchor master rank higher than a value in an anchor master record of the NAN device; or ii) if the NAN beacon indicates an anchor master rank equal to the value in the anchor master record of the NAN device and if a hop count value and an AMBTT value in the NAN beacon frame are larger values in the anchor master record.

NAN Synchronization

NAN devices (terminals) participating in the same NAN Cluster may be synchronized with respect to a common clock. A TSF in the NAN cluster can be implemented through a distributed algorithm that should be performed by all the NAN devices. Each of the NAN devices participating in the NAN cluster may transmit NAN synchronization beacon frame (NAN sync beacon frame) according to the above-described algorithm. The NAN device may synchronize its clock during a discovery window (DW). A length of the DW corresponds to 16 TUs. During the DW, one or more NAN devices may transmit synchronization beacon frames in order to help all NAN devices in the NAN cluster synchronize their own clocks.

NAN beacon transmission is distributed. A NAN beacon frame is transmitted during a DW period existing at every 512 TU. All NAN devices can participate in generation and transmission of the NAN beacon according to their roles and states. Each of the NAN devices should maintain its own TSF timer used for NAN beacon period timing. A NAN synchronization beacon interval can be established by the NAN device that generates the NAN cluster. A series of TBTTs are defined so that the DW periods in which synchronization beacon frames can be transmitted are assigned exactly 512 TUs apart. Time zero is defined as a first TBTT and the discovery window starts at each TBTT.

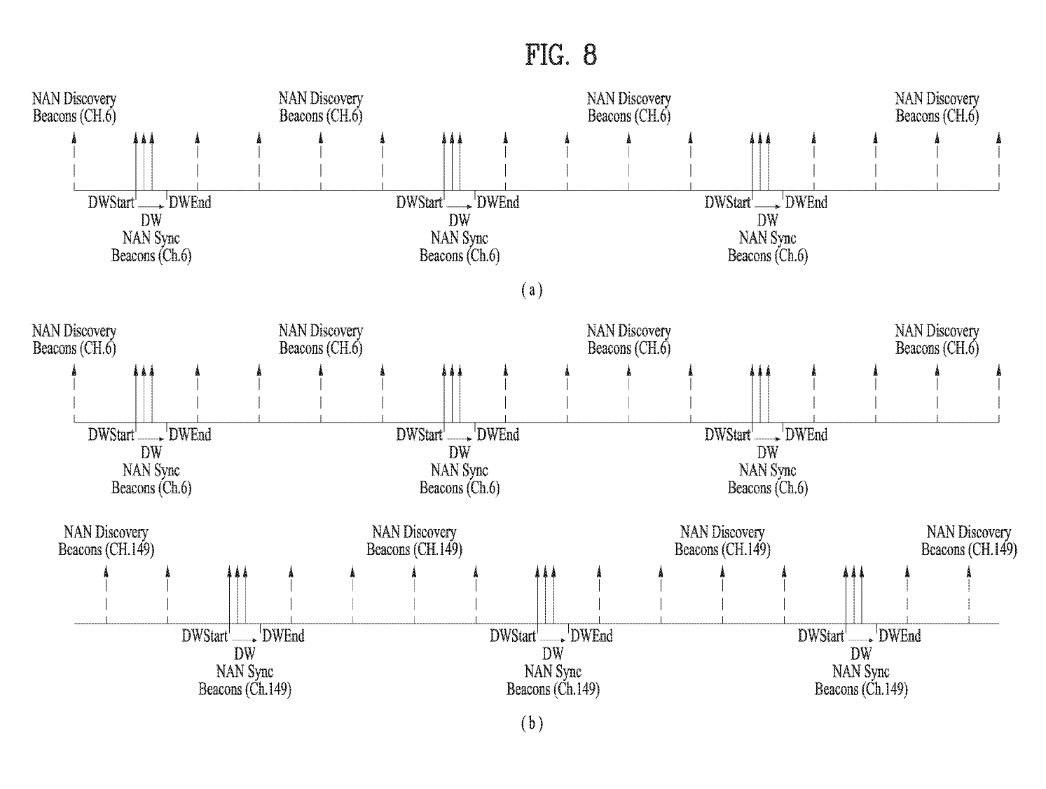

Each NAN device serving as a NAN master transmits a NAN discovery beacon frame from out of a NAN discovery window. On average, the NAN device serving as the NAN master transmits the NAN discovery beacon frame every 100 TUs. A time interval between consecutive NAN discovery beacon frames is smaller than 200 TUs. If a scheduled transmission time overlaps with a NAN discovery window of the NAN cluster in which the corresponding NAN device participates, the NAN device serving as the NAN master is able to omit transmission of the NAN discovery beacon frame. In order to minimize power required to transmit the NAN discovery beacon frame, the NAN device serving as the NAN master may use AC_VO (WMM Access Category—Voice) contention setting. FIG. 8 illustrates relations between a discovery window and a NAN discovery beacon frame and transmission of NAN synchronization/discovery beacon frames. Particularly, FIG. 8(a) shows transmission of NAN discovery and synchronization beacon frames of a NAN device operating in 2.4 GHz band. FIG. 8(b) shows transmission of NAN discovery and synchronization beacon frames of a NAN device operating in 2.4 GHz and 5 GHz bands.

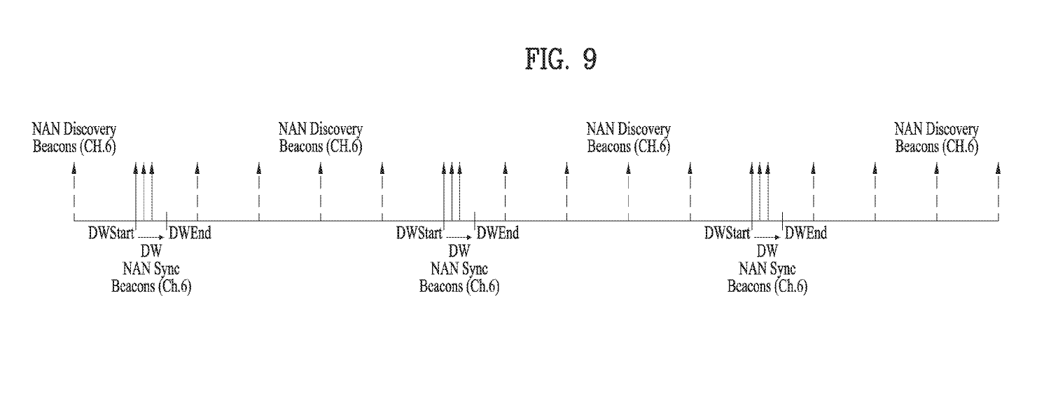

FIG. 9 is a diagram illustrating a discovery window. As mentioned in the foregoing description, each NAN device performing a master role transmits a synchronization beacon frame within a discovery window and transmits a discovery beacon frame at the outside of the discovery window. In this case, as mentioned in the foregoing description, the discovery window can be repeated in every 512 TU. In this case, duration of the discovery window may correspond to 16 TUs. In particular, the discovery window can last during 16 TUs. In this case, for example, all NAN devices belonging to a NAN cluster may awake at every discovery window to receive a synchronization beacon frame from a master NAN device. By doing so, the NAN cluster can be maintained. In this case, if all NAN devices awake at every discovery window in a fixed manner, power consumption of the devices may get worse. Hence, it is necessary to have a method of reducing power consumption by dynamically controlling duration of a discovery window while synchronization is maintained in a NAN cluster.

For example, as mentioned in the foregoing description, a NAN device may operate in 2.4 GHz band or 5 GHz band. As a different example, a NAN device may operate in sub 1 GHz band. For example, a NAN device can be configured to support IEEE 802.11ah that supports sub 1 GHz band. For example, if a NAN device supports 900 MHz, it may have link quality and a physical model different from link quality and a physical model in 2.4 GHz or 5 GHz.

For example, if a NAN device supports 900 MHz, the NAN device can send a signal farther and perform communication in a wider range. In this case, data communication can be performed between NAN devices and data can be exchanged between NAN devices. In this case, since the data exchange is performed based on the data communication, a problem may exist in efficiently managing power in the NAN device. In order to solve the problem, it may differently configure a method of configuring a discovery window period. FIG. 9 shows a basic structure that a synchronization beacon frame is transmitted within a discovery window and a discovery beacon frame is transmitted at the outside of the discovery window. The basic structure can also be similarly applied to a NAN device supporting 900 MHz band.

For example, as mentioned in the foregoing description, a NAN device can transmit a service discovery frame (SDF) in a discovery window. In this case, the NAN device can discover a different NAN device capable of supporting a specific service through the service discovery frame. In this case, the service discovery frame may have a frame format described in Table 3 in the following.

TABLE 3

| | Size | Value | |
|---|---|---|---|
| Field | (Octets) | (Hex) | Description |
| Category | 1 | 0x04 | IEEE 802.11 Public Action Frame |
| Action Field | 1 | 0x09 | IEEE 802.11 Public Action Frame |
| | | | Vendor Specific |
| OUI | 3 | 0x50- | Wi-Fi Alliance specific OUI |
| | | 6F-9A | |
| OUI Type | 1 | 0x13 | Identifying the type and version |
| | | | of the NAN |
| NAN Attributes | Variable | Variable | One or more NAN Attributes |

Referring to Table 3, a service discovery frame can include a NAN attribute field and the NAN attribute field can be defined to have different information according to a service discovery status.

Table 4 in the following shows a general format of the NAN attribute field of Table 3. In this case, the NAN attribute field can include at least one selected from the group consisting of an attribute ID field, a length field, and an attribute body field. In this case, the attribute body field may have a variable size and include different information based on a NAN attribute.

TABLE 4

| | Size | Value | |
|---|---|---|---|
| Field | (Octets) | (Hex) | Description |
| Attribute ID | 1 | Variable | Identifies the type of NAN |
| | | | attribute as defined in Table 3 |
| Length | 2 | Variable | Length of the following fields in |
| | | | the attribute |
| Attribute Body | Variable | Variable | NAN Attribute specific |
| Field | | | information fields |

Table 5 in the following shows attribute informations capable of being included in a beacon frame and a service discovery frame. In this case, the attribute ID field shown in Table 4 can be defined by a different value to indicate a different attribute. For example, each of the attribute informations may or may not be included in a beacon frame and a service discovery frame. And, for example, specific attribute information among the attribute informations can be mandatorily (represented as “M” in the Table 5) included or can be optionally (represented as “O” in the Table 5) included.

TABLE 5

| Attribute | | NAN Beacons | | NAN SDF |
|---|---|---|---|---|
| ID | Description | Sync | Discovery | NO |
| 0 | Master Indication Attribute | YES/M | YES/M | NO |
| 1 | Cluster Attribute | YES/M | YES/M | NO |
| 2 | Service ID List Attribute | YES/O | YES/O | YES/M |
| 3 | Service Descriptor Attribute | NO | NO | YES/O |
| 4 | NAN Connection Capability | NO | NO | YES/O |
| | Attribute | | | |
| 5 | WLAN infrastructure | NO | NO | YES/O |
| | Attribute | | | |
| 6 | P2P Operation Attribute | NO | NO | YES/O |
| 7 | IBSS Attribute | NO | NO | YES/O |
| 8 | Mesh Attribute | NO | NO | YES/O |
| 9 | Further NAN Service | NO | NO | YES/O |
| | Discovery Attribute | | | |
| 10 | Further Availability Map | NO | NO | YES/O |
| | Attribute | | | |
| 11 | Country Code Attribute | YES/O | YES/O | YES/O |
| 12 | Ranging Attribute | NO | NO | YES/O |
| 13 | Cluster Discovery Attribute | NO | NO | NO |
| 14-220 | Reserved | NA | NA | NA |
| 221 | Vendor Specific Attribute | YES/O | YES/O | YES/O |
| 222-255 | Reserved | NA | NA | NA |

As mentioned in the foregoing description, the attribute body information of Table 4 can be differently configured based on an attribute ID of Table 5.

In this case, legacy NAN terminals did not perform a function of exchanging a data by forming a data link or a data path. And, the legacy NAN terminals did not perform a function of measuring distance information and other measurement informations of a different NAN terminal via ranging measurement. And, the legacy NAN terminals did not perform a function of searching for a service on behalf of a different NAN terminal as a proxy function. As a different example, similar to a case of using a different interface, the legacy NAN terminal did not perform an additional service discovery function as a service discovery method. As a further different example, the legacy NAN terminal did not perform a function of exchanging information on a persistent group and a function of forming a persistent group.

In particular, it may add not only a service discovery function but also additional functions between NAN terminals. In this case, since it is unable to update the whole system whenever a new function is added to NAN terminals, it is necessary to operate in consideration of backward compatibility with a legacy NAN terminal. Hence, it is necessary to define a NAN capability attribute format in consideration of a new function and the backward compatibility. In this case, a NAN capability attribute can be indicated using a reserved value (one of 14 to 255) shown in Table 5. In particular, the NAN capability attribute can be defined as a new attribute. In this case, for example, the NAN capability attribute field can be configured as Table 6 in the following based on Table 4. In particular, bitmap information on NAN capability can be included in the attribute body field. In this case, the bitmap information on the NAN capability can be represented as Table 7 in the following. In particular, information on whether or not a new function is supported can be represented by each bit.

TABLE 6

| | Size | Value | |
|---|---|---|---|
| Field | (Octets) | (Hex) | Description |
| Attribute ID | 1 | 0xZZ | Identifies the type of NAN2 capability |
| | | | attribute |
| Length | 1 | 1 | Length of the following fields in the |
| | | | attribute |
| NAN2 | 1 | Variable | A set of parameters indicating NAN2 |
| Capability | | | Device's capabilities, as defined in |
| Bitmap | | | Table 7 |

TABLE 7

| Bit(s) | Information | Notes |
|---|---|---|
| 0 | NAN2 extended | The NAN2 extended service discovery field |
| | service discovery | shall be set to 1 if the NAN2 Device supports |
| | | NAN2 extended service discovery, and is set to |
| | | 0 otherwise. |
| 1 | NAN2 Ranging | The NAN2 Ranging field shall be set to 1 if the |
| | | NAN2 Device supports NAN2 Ranging, and is |
| | | set to 0 otherwise. |
| 2 | NAN Data Link | The NAN Data Link field shall be set to 1 when |
| | | the NAN2 Device supports NAN2 Link, and is |
| | | set to 0 otherwise. |
| 3 | NAN2 discovery | The NAN2 discovery proxy field shall be set to |
| | proxy | 1 when the NAN2 Device supports NAN2 |
| | | discovery proxy, and is set to 0 otherwise. |
| 4-7 | Reserved | — |

More specifically, it may be able to define a bit for NAN extended service discovery in a NAN capability bitmap. In this case, whether or not a NAN terminal performs extended service discovery as a new function can be indicated by the NAN extended service discovery bit.

And, a bit for NAN ranging can be added to the NAN capability bitmap. In this case, whether or not a NAN terminal supports a ranging function for measuring a distance from a different NAN terminal as a new function can be indicated by the NAN ranging bit.

And, it may be able to define a bit for a NAN data link in the NAN capability bitmap. In this case, whether or not a NAN terminal supports a function of exchanging a data with a different NAN terminal as a new function can be indicated by the NAN data link bit.

And, it may be able to define a bit for a NAN discovery proxy. In this case, whether or not a NAN terminal supports a proxy function corresponding to a function of performing service discovery instead of a different NAN terminal as a new function can be indicated by the NAN discovery proxy bit.

And, it may be able to define a bit for NAN persistent group capability in one of reserved bits shown in Table 7. In this case, for example, as a new function, when a NAN terminal forms a data link or a group with a different NAN terminal according to a service, whether or not the NAN terminal supports a function of forming a persistent group can be indicated by the NAN persistent group bit. In particular, information on a new function added to NAN can be included in the NAN attribute field as single attribute information. It is able to maintain backward compatibility with a legacy system based on the information.

As a further different example, the NAN capability bitmap can be included in a legacy service descriptor attribute (SDA). In particular, when an attribute ID shown in Table 5 corresponds to 3, information on Table 7 can be included in the SDA. In this case, for example, the SDA can be included in a service discovery frame or a sync/discovery beacon frame. And, the SDA can be included in a newly defined frame as well, by which the present invention may be non-limited. In this case, for example, the SDA can be represented as Table 8 in the following. In this case, a NAN capability information field can be included as a new field among SDA fields shown in Table 8. In this case, information included in the NAN capability information field may be identical to the information shown in Table 7.

TABLE 8

| | Size | Value | |
|---|---|---|---|
| Field | (Octets) | (Hex) | Description |
| Attribute ID | 1 | 0x03 | Identifies the type of NAN attribute |
| Length | 2 | Variable | Length of the following fields in the |
| | | | attribute |
| Service ID | 6 | Variable | Mandatory field that contains the |
| | | | hash of the Service Name |
| Instance ID | 1 | Variable | Publish_ID or Subscribe_ID |
| Requestor | 1 | Variable | Insstance ID from the frame that |
| Instance ID | | | triggered the transmission if |
| | | | available, otherwise set to 0x00 |
| Service | 1 | Variable | Mandatory field that defines the |
| Control | | | Service Control bitmap |
| Binding | 0 or 2 | 0x0000 to | Optional field that indicates the |
| Bitmap | | 0xFFFF | binding of the SDA to post discovery |
| | | | connection attributes |
| Matching | 0 or 1 | Variable | An optional field and present if a |
| Filter | | | matching service discovery filter is |
| Length | | | used |
| Matching | Variable | Variable | An optional field that is a sequence |
| Filter | | | of length and value pairs that identify |
| | | | the matching service discovery filters |
| Service | 0 or 1 | Variable | An optional field and present if a |
| Response | | | service response filter is used |
| Filter | | | |
| Length | | | |
| Service | Variable | Variable | An optional field is a sequence of |
| Response | | | length and value pairs that identify |
| Filter | | | the matching service response filters |
| Service Info | 0 or 1 | Variable | An optional field and present if |
| Length | | | service specific information is used |
| Service Info | Variable | Variable | An optional field that contains the |
| | | | service specific information. Its |
| | | | content may be determined by the |
| | | | application and not specified herein. |
| NAN2 | 1 | Variable | Mandatory filed that defines the |
| Capability | | | NAN2 capability bitmap as |
| info | | | defined in Table 7 |

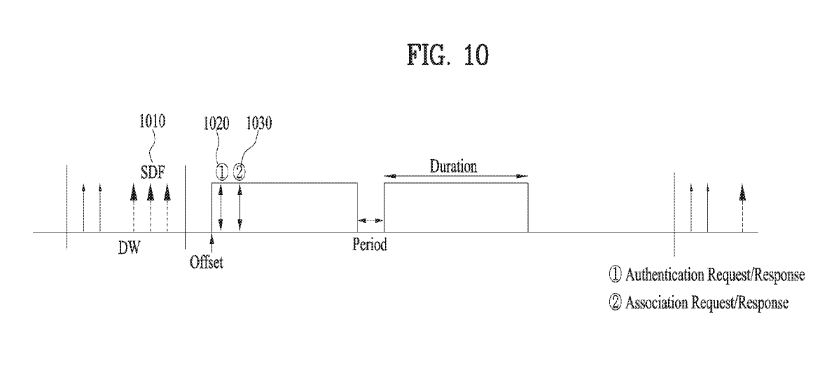

FIG. 10 is a diagram illustrating a method of configuring a data link.

A legacy NAN device performs service discovery only. The legacy NAN device does not perform data exchange. In this case, since a service is mutually provided between NAN devices, data exchange for the service is required and it is necessary to define the data exchange. In this case, it may additionally define a NAN data link (NDL) as a period for transmitting data for the service mutually provided between the NAN devices. The NAN devices can exchange data in a data path or a data duration belonging to the NAN data link. In this case, for example, when the NAN devices exchange data, the NAN device can perform authentication and association related to data transmission based on an attribute or a characteristic of the data.

a NAN device can search for NAN devices supporting a specific service using the service discovery frame. The NAN device discovers a NAN device supporting a specific service via the service discovery frame and may be then able to exchange data for the specific service with the discovered NAN device. In this case, for example, the data exchanged between the NAN devices may correspond to data distinguished from each other according to a service or a service application. In particular, it may be able to configure the NAN device to discover a NAN device according to a service and perform data transmission according to a service.

When the NAN device exchanges data for the specific service with the discovered NAN device, the NAN device can determine whether or not it is necessary to perform authentication and association on the data of the specific service. For example, similar to the data transmission, the authentication and the association can also be determined according to a service.

More specifically, the NAN device can support a plurality of services or a plurality of service applications. In this case, data for a service among a plurality of the services may correspond to data requiring security. In particular, data exchange for a specific service can be performed on a specific NAN device only to which a service access is permitted. On the contrary, among a plurality of the services, in case of a service not requiring security or a service irrespective of whether or not data is opened, data of the service can be exchanged without an authentication procedure or an association procedure to omit an unnecessary procedure. In particular, when NAN devices exchange data with each other, the NAN devices can determine whether or not the data exchange, the authentication procedure and the association procedure are necessary according to a service.

For example, a first NAN device can discover a second NAN device supporting a first service via a service discovery frame. In this case, as mentioned in the foregoing description, the service discovery frame can be transmitted in a discovery window. The first NAN device can exchange data for the first service with the second NAN device after the second NAN device supporting the first service is discovered. In this case, the first NAN terminal can perform authentication/association in data transmission for the first service and may be able to exchange information with the second NAN terminal based on the authentication/association.

More specifically, referring to FIG. 10, the first NAN device can transmit a service discovery frame 1010 within a discovery window. In this case, as mentioned in the foregoing description, the service discovery frame 1010 may correspond to a mandatorily exchanged frame. Subsequently, the first NAN device can transmit data by initiating a data path or a data duration at the timing away from the timing at which the discovery window ends as much as an offset value. In this case, for example, a period, which is not the discovery window, may correspond to the aforementioned NAN data link. In particular, data path or data duration for transmitting data can be configured from among the NAN data link.

In this case, for example, the attribute information included in the service discovery frame can include at least one selected from the group consisting of information on a data path or a data duration for which data is transmitted, offset information, and period information of data duration. In particular, information necessary for transmitting data can be included in the attribute information which is included in the service discovery frame.

And, for example, the first NAN device can exchange an authentication request/response frame 1020 with the second NAN device before data is exchanged between the first NAN device and the second NAN device after a data path is initiated. In this case, for example, the authentication request/response frame can be exchanged only when authentication attribute information is included in the service discovery frame when the first NAN device determines that the authentication is necessary in transmitting the data for the first service. And, for example, the authentication request/response frame can be exchanged using the authentication attribute information included in the service discovery frame. Subsequently, the first NAN device can exchange an association request/response frame 1030 with the second NAN device.

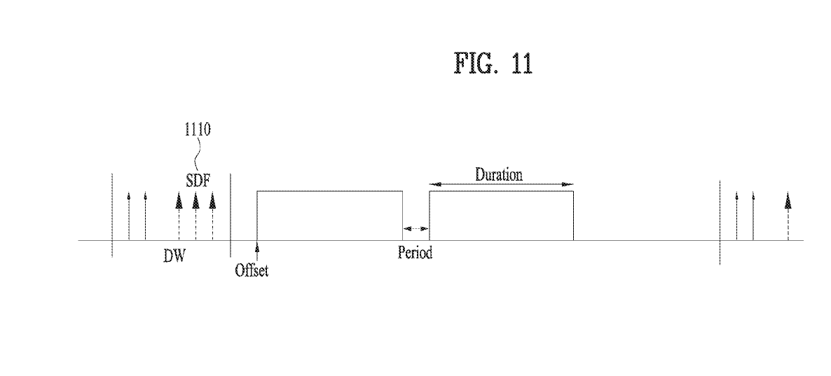

FIG. 11 is a diagram illustrating a method for a NAN terminal to form a data path based on a NAN persistent data group.

As mentioned in the foregoing description, two NAN terminals form a NAN data link and can perform data exchange in a NAN data path. In this case, for example, two or more NAN terminals can form a NAN data group or a NAN service group. And, for example, two or more NAN terminals can form a NAN data cluster. In the following, although it is referred to as the NAN data group, the NAN service group and the NAN data cluster can also be identically used.

More specifically, two or more NAN terminals can form a NAN data group for a specific service. In this case, each of the NAN terminals belonging to the NAN data group can perform data exchange on the specific service based on a data link configured between the NAN terminals. In this case, for example, the NAN data group can be formed based on the specific service. In particular, the NAN data group may correspond to a group which is formed according to a service. In this case, for example, if a NAN terminal is able to perform data exchange for a specific service with a different NAN terminal, the NAN terminal and the different NAN terminal can form a NAN data group. When the NAN terminal intends to perform data exchange for a specific service, the NAN terminal can join a NAN data group which is already formed for the specific service. In particular, the NAN terminal can generate or join a NAN data group based on a service. In this case, for example, the NAN terminal can form a NAN persistent data group (or, a NAN persistent data path group) for a specific service. In particular, once a NAN data group is formed, the NAN terminal can form or join the NAN data group again.

For example, it may be able to indicate whether or not a NAN terminal is equipped with a NAN persistent data group function. In this case, whether or not the NAN persistent data group function is supported can be indicated by a bit used in the aforementioned NAN capability field. In particular, whether or not a NAN terminal supports the NAN persistent data group function can be indicated based on information included in a service discovery frame or a sync/discovery beacon frame. And, for example, information on whether or not a NAN terminal supports the NAN persistent data group function can be included in a frame using a method different from the aforementioned method, by which the present invention may be non-limited. In this case, the NAN terminal can transmit a frame in a publish type (solicited and unsolicited type) or a subscribe type (passive and active type). The information on whether or not a NAN terminal supports the NAN persistent data group function can be included in the frame.

If it is indicated that the NAN terminal supports the NAN persistent data group function, information on a NAN persistent data group can be included in a frame transmitted by the NAN terminal. In this case, for example, the informations on the NAN persistent data group are shown in Table 9 in the following. In particular, the NAN persistent data group can include address information corresponding to a NAN interface address and/or IPv6 address. And, the NAN persistent data group can include information for identifying a NAN data group as NAN data group (or, NAN data path group) ID information. In this case, for example, similar to an SSID (service set identifier) of a WLAN infrastructure, the NAN data group ID can perform a function of identifying a specific group. And, the NAN persistent data group can include scheduling information. For example, the scheduling information can include information on a scheduling owner in the NAN persistent data group, information on a service provider, paging time, duration, and period information. In particular, the NAN persistent data group can include information necessary for a NAN terminal to perform data exchange with a different NAN terminal in a NAN data group.

TABLE 9

Persistent group info.
NAN interface address/IPv6 address
NAN DataPath Group ID
Scheduling Info
Scheduling owner
Service provider
Paging Time/Duration/period

And, for example, not only the information on the NAN persistent data group but also informations capable of identifying a previous NAN data path can be included in a frame. For example, the frame can further include at least one selected from the group consisting of a NAN cluster ID, a service ID, and NAN interface address information. In particular, if a NAN terminal supports the NAN persistent data group function, information on the NAN persistent data group and information for checking a previous NAN data path can be included in the frame. The NAN terminal can provide the information on the NAN persistent data group to a different NAN terminal via the frame and may be able to quickly configure a NAN data path. Regarding this, it shall be described later. And, for example, the frame transmitted by the NAN terminal may correspond to a service discovery frame.

In this case, referring to FIG. 11, as mentioned in the foregoing description, a NAN terminal transmits a service discovery frame 1110 in a discovery window period and can form a data path after an offset period arrives. In particular, the NAN terminal can provide information on a NAN persistent data group to a different NAN terminal in the course of transmitting the service discovery frame 1110.

In this case, unlike FIG. 10, the NAN terminal may omit an authentication procedure in the course of forming a data path. In particular, the NAN terminal can omit an authentication frame exchange procedure. In this case, the NAN terminal can omit the authentication procedure using credential information. And, for example, the NAN terminal can simplify the authentication procedure using the credential information. In this case, the credential information may correspond to information stored in the NAN terminal when the NAN persistent data group is firstly formed.

More specifically, as mentioned in the foregoing description, it may indicate that the NAN terminal supports the NAN persistent data group function. In this case, the NAN terminal forms a data path with other NAN terminals and can join a NAN data group. In this case, for example, since the NAN terminal supports the NAN persistent data group function, the NAN terminal can determine the NAN data group as the NAN persistent data group. In this case, the NAN terminal can store credential information on the firstly connected NAN persistent data group in the inside of the NAN terminal. For example, the NAN terminal can include a memory and the credential information can be stored in the memory. In this case, when a NAN persistent data group is formed, a key value necessary for authenticating the NAN persistent data group can be stored in the credential information.

And, for example, when a NAN persistent data group is formed, a scheduling owner or a service provider can be set to the NAN persistent data group. In particular, it may be able to configure a NAN terminal for controlling data paths of a plurality of NAN terminals in the NAN persistent data group. In this case, for example, a NAN terminal, which is not a scheduling owner or a service provider, can perform authentication with the scheduling owner or the service provider using a symmetric key. In this case, for example, the NAN terminal can store a shared key value, which is firstly generated with the scheduling owner or the service provider, in the credential information. In particular, information on a key shared as a symmetric key can be stored in the inside of the NAN terminal.

And, for example, a NAN terminal, which is not a scheduling owner or a service provider, can perform authentication with the scheduling owner or the service provider using an asymmetric key. In this case, for example, the NAN terminal can store a public key of the scheduling owner or the service provider in the credential information. In particular, information on a key provided as an asymmetric key can be stored in the inside of the NAN terminal. In particular, if the NAN terminal receives a frame including NAN persistent group information, the NAN terminal can omit or simplify an authentication procedure.

And, for example, if a NAN terminal receives a frame including NAN persistent group information, the NAN terminal can omit an association procedure. And, for example, the NAN terminal can newly start the association procedure. In this case, for example, when the NAN terminal newly starts the association procedure, information shown in Table 10 in the following can be used and the information may correspond to information used in a legacy system. In particular, it may be able to indicate information on whether or not the NAN terminal supports a NAN persistent data group. The NAN terminal can use a previous data path via the information, by which the present invention may be non-limited.

[Table 10]
Operating channel
Reassign ID having a function similar to AID (information necessary for performing paging procedure)
Power capability (information related to 802.11 spec, based 11n, 11ac, 11ah)
QoS capability (information related to 802.11 spec, based 11n, 11ac, 11ah)
QoS traffic capability (information related to 802.11 spec, based 11n, 11ac, 11ah)
Supported channels
Supported operating channels

[symbol]

As a different example, the NAN terminal completes discovery for a service/device using a service discovery frame and may be then able to indicate whether or not the NAN terminal supports a NAN persistent data group function at a start point of an authentication/association procedure for configuring a NAN data path.

More specifically, referring to FIG. 11, a NAN terminal can transmit a service discovery frame 1110 in a discovery window. In this case, information on whether or not a NAN persistent data group is supported and information on the NAN persistent data group may not be included in the service discovery frame 1110. In particular, a step of performing discovery can be performed in a manner of being identical to a legacy procedure. Subsequently, if an offset period elapses after the discovery window, the NAN terminal can perform an authentication/association procedure. In this case, the NAN terminal is able to check a service by performing discovery. The NAN terminal is able to check whether or not a previous data path is formed for a specific service corresponding to a matched service and check whether or not a NAN data group exists. In particular, a requester NAN terminal (requester, for service negotiation/authentication/association) can indicate whether or not a NAN persistent data group is supported by including information on whether or not the NAN persistent data group is supported at a start point of the authentication/association procedure. Subsequently, a responder NAN terminal (responder) can transmit a confirmation response in response to the information on whether or not the NAN persistent data group is supported.

In particular, if a specific service is discovered according to a discovery result, it may be able to determine whether or not the specific service is supported by a NAN persistent group. In this case, if the NAN persistent group is supported for the specific service and NAN terminals form a NAN data group for the first time, the NAN data group can be formed by storing credential information in the inside of the NAN terminals and performing an authentication/association procedure. If the NAN persistent group is supported for the specific service and a NAN data group is previously formed by NAN terminals, the authentication/association procedure can be omitted or simplified based on NAN persistent data group information to join or generate a NAN data group.

In this case, for example, if a NAN terminal joins a NAN data group, the NAN terminal can inform a different NAN terminal belonging to the NAN data group that the NAN terminal has joined the NAN data group. In this case, for example, the NAN terminal can inform all NAN terminals belonging to the NAN data group or a part of the NAN terminals that the NAN terminal has joined the NAN data group. And, for example, the NAN terminal can inform a scheduler owner or a service provider only belonging to the NAN data group of the join information, by which the present invention may be non-limited.

And, for example, it may be able to update a list of members belonging to a NAN data group. In this case, for example, when a NAN terminal joins the NAN data group and performs an authentication step or an association step, among NAN terminals belonging to the NAN data group, a terminal, which performs authentication or association on the joined NAN terminal, can provide information on the joined NAN terminal to other NAN terminals belonging to the NAN data group. In this case, for example, the information can be shared by determining a new frame for managing a group or in a manner of being included in legacy information. Information on a NAN terminal, which officially leaves the NAN data group, and/or a rule for a NAN terminal not operating for a prescribed period are determined and corresponding list information can be shared with other NAN terminals.

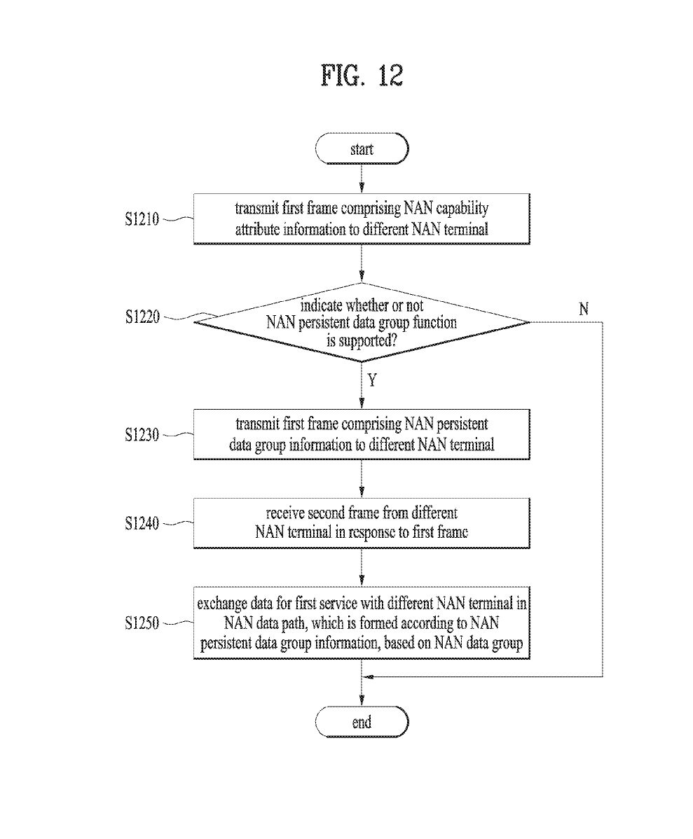

FIG. 12 is a flowchart for a method of configuring a NAN persistent data group.

A NAN terminal can transmit a first frame including NAN capability attribute information to a different NAN terminal [S1210]. In this case, as mentioned earlier in FIGS. 10 to 11, the first frame may correspond to a service discovery frame or a discovery/sync frame. And, the NAN capability attribute information can include information on a new function for the NAN terminal. In this case, the information on the new function for the NAN terminal is included in a frame in a manner of being added as a new field or can be defined in a legacy field as a new value in consideration of backward compatibility with a legacy system.

In this case, a bit indicating whether or not a NAN persistent data group function is supported can be included in the NAN capability attribute information. In particular, it may be able to indicate whether or not a NAN terminal supports the NAN persistent data group function [S1220].

If the NAN terminal supports the NAN persistent data group function, the NAN terminal can transmit NAN persistent data group information to a different NAN terminal by including the NAN persistent data group information in the first frame [S1230]. In this case, as mentioned earlier in FIGS. 10 to 11, information on a NAN data path based on a previously formed NAN data group can be included in the NAN persistent data group information. In this case, as mentioned in the foregoing description, a NAN data group can be configured according to a specific service. In particular, the NAN data group may correspond to a group for a specific service. And, as mentioned in the foregoing description, the NAN persistent data group information can also include information on a NAN data group for a specific service. The NAN terminal can receive a second frame from the different NAN terminal in response to the first frame [S1240]. In this case, as mentioned earlier in FIGS. 10 to 11, the NAN terminal can form a NAN data path after the second frame is received. In this case, for example, if the NAN terminal exchanges the first frame and the second frame with the different NAN terminal, it may correspond to a service discovery procedure. In particular, the NAN terminal can obtain information on the NAN persistent data group via the service discovery procedure.

Subsequently, the NAN terminal and the different NAN terminal can perform data exchange on a first service in the NAN data path, which is formed according to NAN data group information, based on the NAN data group [S1250]. In this case, as mentioned earlier in FIGS. 10 to 11, the NAN terminal can join the NAN data group according to the BAB persistent data group information. In this case, when the NAN terminal firstly joins the NAN data group, the NAN terminal can store information on the NAN data group. Subsequently, when the NAN terminal joins the NAN data group again, the NAN terminal can directly form a NAN data path for the first service using the stored information on the NAN data group without performing authentication and association procedures. By doing so, it may be able to reduce an unnecessary procedure.

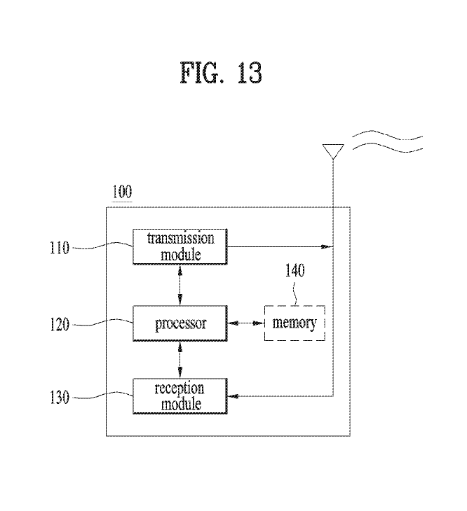

FIG. 13 is a block diagram for a device.

A device may correspond to a NAN device included in a cluster. In this case, as mentioned in the foregoing description, the device can transmit a service discovery frame to another device in a discovery window. By doing so, the device can perform service discovery.

In this case, the device 100 can include a transmission module 110 configured to transmit a radio signal, a reception module 130 configured to receive a radio signal, and a processor 120 configured to control the transmission module 110 and the reception module 130. In this case, the device 100 can perform communication with an external device using the transmission module 110 and the reception module 130. In this case, the external device may correspond to a different device. And, the external device may correspond to a base station. In particular, the external device may correspond to a device capable of performing communication with the device 100, by which the present invention may be non-limited. The device 100 can transmit and receive digital data such as contents using the transmission module 110 and the reception module 130. And, the device 100 can exchange a beacon frame, a service discovery frame, and the like using the transmission module 110 and the reception module 130, by which the present invention may be non-limited. In particular, the device 100 performs communication using the transmission module 110 and the reception module 130 and may be able to exchange information with an external device

According to one embodiment of the present specification, the device 100 can perform data exchange on a specific service. In this case, the processor 120 can control the transmission module 110 to transmit a first frame including NAN capability attribute information to a different NAN terminal. And, the processor 120 controls the reception module 130 to receive a second frame from the different NAN terminal in response to the first frame. And, the processor 120 can perform data exchange for a first service with the different NAN terminal in a NAN data path based on a NAN data group. In this case, for example, among the NAN capability attribute information included in the first frame, a NAN persistent data group capability field can indicate whether or not a NAN persistent data group is supported. In this case, if the NAN persistent data group capability field indicates that a NAN persistent data group function is supported, the first frame including NAN persistent data group information can be transmitted to the different NAN terminal. In this case, as mentioned in the foregoing description, the NAN data path can be formed based on the NAN persistent data group information.

And, for example, the device 100 can further include a memory 140. In this case, the memory 40 can include information received by the device 100 or information necessary for performing an operation. In this case, for example, when the NAN terminal supports the NAN persistent data group, if the NAN terminal joins the NAN data group for the first time, the NAN terminal can store information on a scheduling owner or a service provider of the NAN data group in the memory 140. In particular, the NAN terminal can store the aforementioned credential information in the memory 140, by which the present invention may be non-limited.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

And, both an apparatus invention and a method invention are explained in the present specification and the explanation on both of the inventions can be complementally applied, if necessary.

### INDUSTRIAL APPLICABILITY

Although the present invention is explained under the assumption that the present invention is applied to a NAN wireless communication system, by which the present invention may be non-limited. The present invention can be applied to various wireless systems using the same scheme.

What is claimed is:

1. A method of performing data exchange, which is performed by a NAN (neighbor awareness networking) terminal in a wireless communication system, the method comprising:
transmitting, by a first NAN terminal, a first frame comprising NAN capability attribute information to a second NAN terminal;
receiving a second frame from the second NAN terminal in response to the first frame; and
performing data exchange for a first service with the second NAN terminal in a NAN data path based on a NAN data group,
wherein when a NAN persistent data group capability field among the NAN capability attribute information indicates that the first NAN terminal supports a NAN persistent data group function, the first frame comprising NAN persistent data group information is transmitted to the second NAN terminal, and
wherein the NAN data path is configured based on the NAN persistent data group information.

2. The method of claim 1, wherein the first NAN terminal and the second NAN terminal correspond to NAN terminals which have joined the NAN data group, and
wherein the NAN data group corresponds to a group for the first service.

3. The method of claim 2, wherein when the first NAN terminal firstly joins the NAN data group for the first service, the first NAN terminal performs authentication and association procedures after receiving the second frame from the second NAN terminal and joins the NAN data group based on the NAN persistent data group information.

4. The method of claim 3, wherein the data exchange for the first service is performed in the NAN data path after the first NAN terminal joins the NAN data group.

5. The method of claim 3, wherein when the NAN data group is configured for the first time, the first NAN terminal and the second NAN terminal store information on the NAN data group.

6. The method of claim 2, wherein when the first NAN terminal rejoins the NAN data group for the first service, when the first NAN terminal receives the second frame from the second NAN terminal, the first NAN terminal joins the NAN data group based on first information and the NAN persistent data group information without performing authentication and association procedures.

7. The method of claim 6, wherein the first information corresponds to information stored in the first NAN terminal when the first NAN terminal firstly joins the NAN data group for the first service.

8. The method of claim 6, wherein when the first NAN terminal joins the NAN data group, the second NAN terminal provides information on the first NAN terminal to a different NAN terminal belonging to the NAN data group.

9. The method of claim 1, wherein when the second frame is received from the second NAN terminal, discovery for the first service is completed.

10. The method of claim 1, wherein the first frame and the second frame correspond to frames which are exchanged in a step of configuring the NAN data path for the first service after discovery for the first service is completed.

11. The method of claim 1, wherein the NAN persistent data group information comprises at least one selected from the group consisting of an address, a NAN data group ID, and scheduling information.

12. The method of claim 1, wherein the NAN capability attribute information further comprises at least one field selected from the group consisting of a NAN extended service discovery field, a NAN ranging field, a NAN data link field, and a NAN discovery proxy field.

13. A first NAN terminal performing data exchange in a wireless communication system, the first NAN terminal comprising:
a reception module configured to receive information from an external device;
a transmission module configured to transmit information to an external device; and
a processor configured to control the reception module and the transmission module,
wherein the processor:
controls the transmission module to transmit a first frame comprising NAN capability attribute information to a second NAN terminal,
controls the reception module to receive a second frame from the second NAN terminal in response to the first frame, and
performs data exchange for a first service with the second NAN terminal in a NAN data path based on a NAN data group,
wherein when a NAN persistent data group capability field among the NAN capability attribute information indicates that the first NAN terminal supports a NAN persistent data group function, the first frame comprising NAN persistent data group information is transmitted to the second NAN terminal, and
wherein the NAN data path is configured based on the NAN persistent data group information.

14. The first NAN terminal of claim 13, wherein the first NAN terminal and the second NAN terminal correspond to NAN terminals which have joined the NAN data group and wherein the NAN data group corresponds to a group for the first service.

15. The first NAN terminal of claim 14, wherein when the first NAN terminal firstly joins the NAN data group for the first service, the first NAN terminal performs authentication and association procedures after receiving the second frame from the second NAN terminal and joins the NAN data group based on the NAN persistent data group information.
